(19) United States
(12) Patent Application Publication
(10) Pub. No.: US 2013/0325615 A1
(43) Pub. Date: Dec. 5, 2013

(54) INTELLIGENT INFORMATION INTERACTION SYSTEM

(71) Applicants: Ting Yan Lee, Shenzhen (CN); Chun Sang MA, Shenzhen (CN)

(72) Inventors: Ting Yan Lee, Shenzhen (CN); Chun Sang MA, Shenzhen (CN)

(21) Appl. No.: 13/726,210

(22) Filed: Dec. 23, 2012

(30) Foreign Application Priority Data
Jun. 4, 2012 (CN) 201210180824.2

(51) Int. Cl. G06Q 30/02

(52) U.S. Cl. CPC G06Q 30/0267; G06Q 30/0261
USPC 705/14.58; 705/14.64

(57) ABSTRACT

An intelligent information interaction system includes a data storage unit, a mobile terminal and at least one display object. Each display object is provided with or connected with a wireless transmission device therein, and the mobile terminal is provided with a wireless transmission unit therein. A unique identification is assigned for each display object, and data information displayed on the display object or data information relevant to the data information displayed on the display object, which corresponds to each identification, is stored in the data storage unit. The wireless transmission device regularly or constantly transmits a wireless signal containing the identification of the display object corresponding thereto, and the mobile terminal, after sensing the wireless signal via the wireless transmission unit thereof, acquires the identification, and acquires data information corresponding to the identification from the data storage unit in accordance with the identification.

### BACKGROUND OF THE INVENTION

1. Field of the Invention

The present invention relates to the technical field of wireless communication, and particularly to an intelligent information interaction system.

2. Description of the Prior Art

Nowadays, people's lives have been filled with advertisements in various forms: posters on bus stop signs, television advertisements, outdoor big-screen advertisements, building advertisements, subway advertising machines, and the like. However, advertisers and investors are unaware of how much advertising revenue can be actually attained from advertisements that easily cost hundreds of thousands and even millions of dollars every month, how many people pay attention to these advertisements, and if the public is interested in these advertisements.

In addition, with the continuous development of advertising technology, more and more advertisement developers have noted the above problems and have tried in different ways to achieve the interaction between advertising machines and advertisement receivers, e.g. touch-interaction type advertising machines, inquiry machines, and other machines that are poplar at present, and these machines are provided for the purpose of collecting and counting the number and personal information of advertisement receivers to further achieve interaction. However, interaction can be realized only in a one-to-one (one advertising machine can be operated only by one person at a time) mode no matter which way is adopted. Moreover, operation of the advertising machine can be performed only at a short distance, which reduces the utilization efficiency of the advertising machine.

At present, there are plenty of advertisement forms in which QR codes, barcodes, and other techniques are used as tools for information storage. However, advertisement receivers can acquire advertisement content only if they stand within a short distance in front of an advertisement medium. In this case, a quite large space on the screen or poster of a display object must be provided for the QR code or the barcode. Unfortunately, this reduces the remaining space that is available for displaying information that is both understandable and intuitive for advertisement receivers, which causes the waste of tremendous advertisement investment of advertisers.

### SUMMARY OF THE INVENTION

The present invention provides an intelligent information system, which is capable of implementing a one-to-multiple and far distance interaction mode, and in particular, can improve the utilization efficiency of advertisements and save the investment cost of advertisements.

The technical proposal below is adopted in the present invention:
in the first technical proposal, an intelligent information interaction system comprises: a data storage unit, a mobile terminal and at least one display object, wherein each display object is provided with or connected to a wireless transmission device therein, and the mobile terminal is provided with a wireless transmission unit therein;
a unique identification is assigned to each display object, and data information displayed on the display object or data information relevant to the data information displayed on the display object, which corresponds to each identification, is stored in the data storage unit;
the wireless transmission device regularly transmits a wireless signal containing the identification of the display object corresponding thereto, and the mobile terminal, after sensing the wireless signal via the wireless transmission unit thereof, acquires the identification, and acquires data information corresponding to the identification from the data storage unit in accordance with the identification.

In the second technical proposal, the intelligent information interaction system of the present invention comprises: a server, a mobile terminal and at least one display object.

A unique identification is assigned to each display object, and data information displayed on the display object or data information relevant to the data information displayed on the display object, which corresponds to each identification, is stored on the server. The position information of each display object is stored on the server.

The mobile terminal acquires own geographical location information and then sends the acquired position information to the server. The server sends the identifications of the display objects within a predetermined range near the mobile terminal to the mobile terminal in accordance with the geographical location information of the mobile terminal and the position information of each display object, and in accordance with the received identifications, the mobile terminal acquires the data information corresponding to the identifications from the server.

In the first technical proposal, the display object in the present invention may be transmitting information to and receiving information from multiple mobile terminals, and each mobile terminal acquires data information from the data storage unit after sensing the display object, so that each mobile terminal can be transmitting information to and receiving information from the data information acquired so as to implement a one-to-multiple interaction operation mode and improve the utilization efficiency of advertisements. Furthermore, the information, such as how many people pay attention and whether advertisement receivers are interested in the displayed advertisement contents, can be captured based upon the operation of information interaction. Moreover, the mobile terminal can acquire the identification of a display object only if the mobile terminal is located within the sensing range of the display object. Thus data information can be acquired remotely in accordance with the identification. In addition, data information can be acquired remotely, so it is not necessary to reserve a large space on the display object for displaying a QR code or a barcode, which can save the investment cost of advertisements.

In the second technical proposal, the display objects of the present invention can be in information interaction with more than one mobile terminal at the same time, and the mobile terminals, after receiving the identifications of the display objects sent by the server, acquire the data information corresponding to the identifications from the server. Thus each of the mobile terminals can be in information interaction with the acquired data information in order to realize a one-to-multiple interaction operation mode and improve the utilization efficiency of advertisements. Further, the information, like how many people pay attention and whether advertisement receivers are interested in the played advertisement contents, can be attained based upon the operation of information interaction. Furthermore, the mobile terminal can acquire the identification of a display object only if this display object is within a predetermined range near the mobile terminal, so the mobile terminal can acquire data information remotely in accordance with the identification. In addition, data information can be acquired remotely, so it is not necessary to reserve a large space on the display object for displaying a QR code or a barcode, which can save the investment cost of advertisements.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of the intelligent information interaction system of the present invention in one embodiment.

FIG. 2 is a functional block diagram of the intelligent information interaction system of the present invention in another embodiment.

### DETAILED DESCRIPTION

Detailed description is made below to the embodiments of the present invention with reference to the drawings.

### Embodiment 1

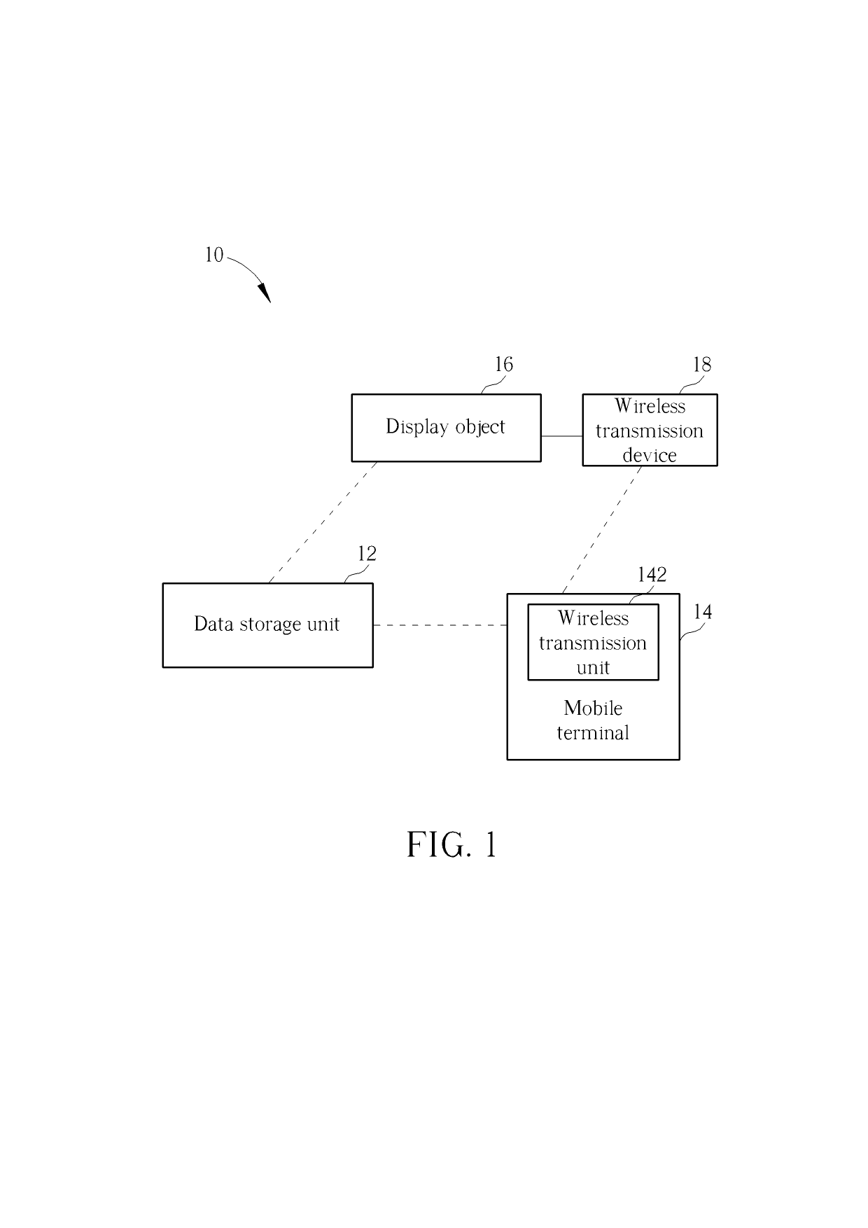

An intelligent information interaction system 10 of a first embodiment of the present invention, shown in FIG. 1, comprises a data storage unit 12, a mobile terminal 14, and at least one display object 16, wherein each display object 16 is provided with or connected with a wireless transmission device 18 therein, and the mobile terminal 14 is provided with a wireless transmission unit 142 therein.

A unique identification is assigned to each display object 16, and data information displayed on the display object 16 or data information relevant to the data information displayed on the display object 16, which corresponds to each identification, is stored in the data storage unit 12, and the relevant data information may be more detailed information of the display object 16. The data information stored in the data storage unit 12 maybe videos, website links, words, pictures, advertisement information, coupons or movie tickets, etc. The data information displayed on each display object 16 or the relevant data information can be stored in the data storage unit 12 and corresponds to the identification of each display object 16, and the data information stored is updated by the data storage unit 12 in real-time.

The wireless transmission device 18 regularly or constantly transmits a wireless signal containing the identification of the display object 16 corresponding thereto, and the mobile terminal 14, after sensing the wireless signal via the wireless transmission unit 142 thereof, acquires the identification, and acquires data information corresponding to the identification from the data storage unit 12 in accordance with the identification.

The data storage unit 12 maybe a remote server, and the mobile terminal 14 acquires the data information on the server by means of wired or wireless access to the Internet or any form of network. The data storage unit 12 may also be a local memory, and the mobile terminal 14 acquires the data information on the memory by means of wireless data transmission. The mobile terminal 14 maybe mobile devices such as mobile phones, and the wireless transmission unit 142 and the wireless transmission device 18 may be Bluetooth modules, WIFI modules, ultrasound communication modules, camera modules, microphone modules, etc.

Each display object 16 maybe in information interaction with multiple mobile terminals 14, and each mobile terminal 14 acquires data information from the data storage unit 12 after sensing the display object 16, so that each mobile terminal 14 can be in information interaction with the data information acquired so as to implement a one-to-multiple interaction operation mode and improve the utilization efficiency of advertisements. Additionally, the information, such as many people pay attention and whether advertisement receivers are interested in the played advertisement contents, can be attained based upon the operation of information interaction. Moreover, the mobile terminal 14 can acquire the identification of a display object 16 only if the mobile terminal 14 is located within the sensing range of the display object 16. Thus data information can be acquired remotely in accordance with the identification. In addition, data information can be acquired remotely, so a quite large space on the display object 16 for QR codes or barcodes does not need to be reserved, which saves the investment cost of advertisements.

To enable the mobile terminal 14 to acquire data information more accurately so as to achieve the function of accurate positioning, in a preferred embodiment, the orientation and the predetermined viewable angle of the display object 16 can be preset. That is, the orientation and the predetermined viewable angle of the display object 16 can be set properly during initialized installation, and can be set in consideration of actual road condition or the orientation of the display object 16.

The wireless signal transmitted by the wireless transmission device 18 further comprises the orientation and the predetermined viewable angle of the display object 16, and after sensing the wireless signal, the mobile terminal 14 acquires the orientation and the predetermined viewable angle of the display object 16 and forms a sector at the predetermined viewable angle spreading to the left and right sides by taking the orientation of the mobile terminal 14 as a central axis, wherein the sector serves as a sensing area of the mobile terminal 14, and the mobile terminal 14 then determines whether the display object 16 is within the sensing area of the mobile terminal 14 according to the orientation of the display object 16; if so, the mobile terminal 14 acquires data information from the data storage unit 12 according to the identification of the display object 16; and if not, no data information is acquired any more.

In addition, the orientation and the predetermined viewable angle of each display object 16 may also be stored in the corresponding wireless transmission device 18 or stored in the data storage unit 12. In this case, the orientation and the predetermined viewable angle of the display object 16 can be excluded from the wireless signal transmitted by the wireless transmission device 18.

After sensing the wireless signal transmitted by the wireless transmission device 18, the mobile terminal 14 is in information interaction with the wireless transmission device 18 or the data storage unit 12 to acquire the orientation and the predetermined viewable angle of the display object 16, and forms a sector area at the predetermined viewable angle spreading to the left and right sides by taking the orientation of the mobile terminal 14 as a central axis, wherein the sector area serves as a sensing area of the mobile terminal 14, and the mobile terminal 14 then judges whether the display object 16 is within the sensing area of the mobile terminal 14 according to the orientation of the display object 16; if so, the mobile terminal 14 acquires data information from the data storage unit 12 according to the identification of the display object 16; and if not, no data information is acquired any more.

To store the identification, orientation and predetermined viewable angle of the display objects 16 more simply and conveniently, the identification, orientation and predetermined viewable angle of each display object 16 can be described by a dedicated naming rule. When the orientation and predetermined viewable angle of the display objects 16 are stored in the data storage unit 12 or the wireless transmission device 18, the orientation and predetermined viewable angle of each display object 16 can be described by a dedicated naming rule.

Multiple display objects 16 are possibly located within the sensing area of the mobile terminal 14 since there may be multiple display objects 16 in front of the mobile terminal 14. In order to prevent erroneous sensing or positioning at this time, the mobile terminal 14 determines whether a display object 16 is located closer in front of the front face of the mobile terminal 14 in accordance with own orientation and the orientation of this display object 16 when multiple display objects 16 are located within the sensing area of the mobile terminal 14. If one display object 16 is located in front of the front face of the mobile terminal 14, the mobile terminal 14 acquires the corresponding data information from the data storage unit 12 in accordance with the identification of the display object 16. On the other hand, if multiple display objects 16 are located in front of the front face of the mobile terminal 14, the mobile terminal 14 acquires the identification of the display object 16 with the strongest signal intensity or specific signal pattern in accordance with the intensity of the sensed wireless signal, and acquires the corresponding data information from the data storage unit 12 in accordance with the identification of the display object 16.

In order to further achieve accurate positioning, the sensing area is located in front of the front face of the mobile terminal 14, and the area located in front of the back face of the mobile terminal 14 is not set as the sensing area. In this case, when multiple display objects 16 are located within the sensing area of the mobile terminal 14, the mobile terminal 14 directly acquires the identification of the display object 16 with the strongest signal intensity or specific signal pattern in accordance with the intensity of the sensed wireless signal, and acquires the corresponding data information from the data storage unit 12 in accordance with the identification of the display object 16.

In order to further enhance the interaction function of the mobile terminal 14, in a preferred embodiment, the mobile terminal 14, after acquiring the corresponding data information, is in information interaction with other servers via the data information acquired, e.g. opening a website link, purchasing coupons and other interaction operations. Alternatively, the mobile terminal 14 is in information interaction with the display object 16 via the corresponding wireless transmission device 18 in accordance with the data information acquired, in this case, the mobile terminal 14 can be interacted with the display object 16 to further improve the interaction effect.

It shall be noted that the display object 16 discussed above maybe an advertising screen, an advertising machine or other visible object, however, in practical application, the intelligent information interaction system 10 of the present invention is not limited in the field of advertising, but may also be applied to other technical fields, e.g. the field of intelligent homes.

### Embodiment 2

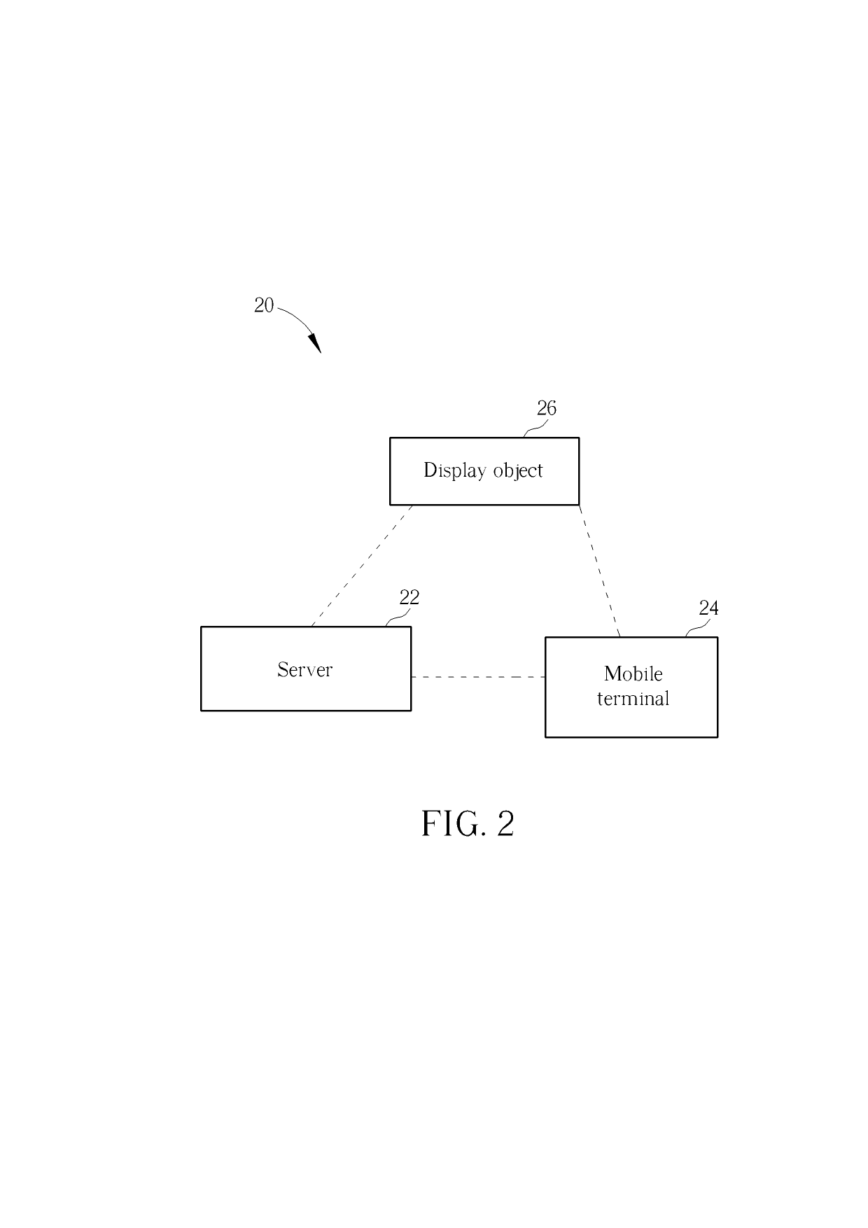

An intelligent information interaction system 20 of a second embodiment of the present invention, shown in FIG. 2, comprises a server 22, a mobile terminal 24, and at least one display object 26, and there may be more than one mobile terminal 24.

A unique identification is assigned to each display object 26, and data information displayed on the display object 26 or data information relevant to the data information displayed on the display object 26, which corresponds to each identification, is stored on the server 22. The relevant data information may be more detailed information, which is displayed incompletely on the display object 26. The data information stored on the server 22 may be videos, website links, words, pictures, advertisement information, coupons or movie tickets, etc. Either the data information displayed on each display object 26 or the relevant data information can be stored on the server 22 and corresponds to the identification of each display object 26, and the stored data information is updated by the server 22 in real time.

The position information of each display object 26 is stored on the server 22, and the server 22 updates the stored position information of each display object 26 in real time. The position information may be geographic coordinates, data and the like that can indicate the information related to the position of display objects 26.

The mobile terminal 24 acquires own position information and then sends the acquired position information to the server 22. The server 22 sends the identifications of the display objects 26 within a predetermined range near the mobile terminal 24 to the mobile terminal 24 in accordance with the position information of the mobile terminal 24 and the position information of each display object 26, and the mobile terminal 24, in accordance with the received identifications, acquires the data information corresponding to the identifications from the server 22.

The predetermined range near the mobile terminal 24 can be preset, and can also be set in accordance with actual requirement, ranging from dozens of meters to thousands of meters. When a display object (s) 26 is (are) within the predetermined range near the mobile terminal 24, the server 22 can send the identification (s) of the display object (s) 26 to the mobile terminal 24, the mobile terminal 24 may receive one or more identifications, and a user selects one of the identifications and can acquire the corresponding data information from the server 22 in accordance with this identification.

The server 22 may be a remote server 22, and the mobile terminal 24 acquires the data information on the server 22 by means of wireless network access. Alternately, the server 22 may be a local server 22, and the mobile terminal 24 acquires the data information on the server 22 by means of wireless data transmission. The mobile terminal 24 may be a mobile phone or other mobile device.

To enable the mobile terminal 24 to acquire data information more accurately so as to achieve the function of accurate positioning, in a preferred embodiment, the orientation and the predetermined viewable angle of each display object 26 are also stored in the server 22. The orientation and the predetermined viewable angle of each display object 26 can be set properly during initialized installation, and can be set in consideration of actual road condition or the orientation of the display object 26 or the like.

The server 22 sends the identification of the display object 26 within a predetermined range near the mobile terminal 24 to the mobile terminal 24, and also sends the orientation and the predetermined viewable angle of the display object 26 to the mobile terminal 24 simultaneously.

The mobile terminal 24 forms a sector area at the predetermined viewable angle spreading to the left and right sides by taking own orientation as a central axis, wherein the sector serves as a sensing area of the mobile terminal 24, and the mobile terminal 24 then determines whether the display object 26 is within the sensing area of the mobile terminal 24 according to the orientation of the display object 26.

If the display object 26 is within the sensing area of the mobile terminal 24, the mobile terminal 24, in accordance with the identification of the display object 26, acquires the data information corresponding to the identification from the server 22. Otherwise, data information is not acquired in accordance with the identification of the display object 26 any more. In this way, the mobile terminal 24 can screen the display objects 26 within the predetermined range nearby to screen the display objects 26 within the sensing area out, thus achieving the function of accurate positioning.

It shall be described that the order and the arrangement way of the identifications, orientations and predetermined viewable angles of display objects 26 are not particularly defined, and the only requirement falls upon sending the identifications, orientations and predetermined viewable angles to the mobile terminal 24. A particular rule, of course, can be adopted for naming, which is convenient for storage and viewing.

There may be multiple display objects 26 within the sensing area of the mobile terminal 24 since there may be multiple display objects 26. In order to prevent erroneous sensing or positioning at this time, the mobile terminal 24 determines whether the display objects 26 are located in front of the front face of the mobile terminal 24 in accordance with own orientation and the orientations of the display objects 26 when there are multiple display objects 26 within the sensing area of the mobile terminal 24.

If one display object 26 is located in front of the front face of the mobile terminal 24, the mobile terminal 24 acquires the corresponding data information from the server 22 in accordance with the identification of this display object 26.

If multiple display objects 26 are located in front of the front face of the mobile terminal 24, the mobile terminal 24 acquires the corresponding data information from the server 22 in accordance with the identification of the display object 26 closest to the mobile terminal 24.

In order to further enhance the interaction function of the mobile terminal 24, in a preferred embodiment, the mobile terminal 24, after acquiring the corresponding data information, is in information interaction with other servers 22 via the data information acquired, e.g. website link opening, coupon purchasing and other interaction operations. In this case, the mobile terminal 24 can interact with the display objects 26 to further improve the interaction effect.

The mobile terminal 24 can acquire own position information in many ways. In the first way the mobile terminal 24 acquires own geographic coordinates from a map service provider at fixed time intervals by means of wireless network access. From the map service provider, such as Baidu map service provider, Google map service provider or the like, the mobile terminal 24 can acquire own geographic coordinates in real time.

In the second way the mobile terminal 24 acquires own geographic coordinates from a map service provider by means of wireless network access upon the reception of a key instruction or a touch instruction. In this case, the mobile terminal 24 acquires own geographic coordinates after receiving the key instruction or the touch instruction in order to prevent the mobile terminal 24 from acquiring own geographic coordinates in real time, thus Internet traffic flow is saved.

In the third way the mobile terminal 24 is provided with a movement mode detection module therein, and the movement mode detection module triggers the mobile terminal 24 to acquire own geographic coordinates from a map service provider by means of wireless network access when detecting that the mobile terminal 24 is under a predetermined movement mode. The movement mode may be a sliding mode, a throwing mode, a shaking mode and the like, the mobile terminal 24 can be triggered to acquire own position information only if the mobile terminal 24 is under such movement modes. Therefore, user experience is improved. In addition, the operation of a user on keys or a touch screen is avoided, and the only requirement falls upon keeping the mobile terminal 24 under a certain movement mode mentioned above.

Although only three ways of acquiring position information are listed above, other different ways may be available in practice. For example, the mobile terminal 24 has own longitude and latitude, so acquisition from a map service provider is unnecessary, and these ways are not shown herein.

It shall be described that the display object discussed above may be an advertising screen, an advertising machine or other visible object, however, in practical application, the novel intelligent information interaction system of the present invention is not limited to the application in the field of advertising, but may also be applied to other technical fields, e.g. the field of intelligent homes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An intelligent information interaction system, characterized in that the system comprises: a data storage unit, a mobile terminal and at least one display object, wherein each display object is provided with or connected with a wireless transmission device therein, and the mobile terminal is provided with a wireless transmission unit therein;
a unique identification is assigned to each display object, and data information displayed on the display object or data information relevant to the data information displayed on the display object, which corresponds to each identification, is stored in the data storage unit; and
the wireless transmission device regularly or constantly transmits a wireless signal containing the identification of the display object corresponding thereto, and the mobile terminal, after sensing the wireless signal via the wireless transmission unit thereof, acquires the identification, and acquires data information corresponding to the identification from the data storage unit in accordance with the identification.

2. The intelligent information interaction system according to claim 1, characterized in that: the orientation and the predetermined viewable angle of the display object are preset;
the wireless signal transmitted by the wireless transmission device further comprises the orientation and the predetermined viewable angle of the display object, and after sensing the wireless signal, the mobile terminal acquires the orientation and the predetermined viewable angle of the display object and forms a sector area at the predetermined viewable angle spreading to the left and right sides by taking the orientation of the mobile terminal as a central axis, wherein the sector serves area as a sensing area of the mobile terminal, and the mobile terminal then determines whether the display object is within the sensing area of the mobile terminal according to the orientation of the display object; and when the display object is within the sensing area of the mobile terminal, the mobile terminal acquires data information from the data storage unit according to the identification of the display object.

3. The intelligent information interaction system according to claim 1, characterized in that: the orientation and the predetermined viewable angle of the display object are preset, and the orientation and the predetermined viewable angle of each display object are stored in the corresponding wireless transmission device or stored in the data storage unit;
after sensing the wireless signal from the wireless transmission device, the mobile terminal is in information interaction with the wireless transmission device and the data storage unit to acquire the orientation and the predetermined viewable angle of the display object and form a sector area at the predetermined viewable angle spreading to the left and right sides by taking the orientation of the mobile terminal as a central axis, wherein the sector area serves as a sensing area of the mobile terminal, and the mobile terminal then determines whether the display object is within the sensing area of the mobile terminal according to the orientation of the display object; and when the display object is within the sensing area of the mobile terminal, the mobile terminal acquires data information from the data storage unit according to the identification of the display object.

4. The intelligent information interaction system according to claim 1, characterized in that: after acquiring the corresponding data information, the mobile terminal transmits information to and receives information from other servers in accordance with the data information acquired, or transmits information to and receives information from the display object via the corresponding wireless transmission device in accordance with the data information acquired.

5. The intelligent information interaction system according to claim 2, characterized in that: after acquiring the corresponding data information, the mobile terminal transmits information to and receives information from other servers in accordance with the data information acquired, or transmits information to and receives information from the display object via the corresponding wireless transmission device in accordance with the data information acquired.

6. The intelligent information interaction system according to claim 3, characterized in that: after acquiring the corresponding data information, the mobile terminal transmits information to and receives information from other servers in accordance with the data information acquired, or transmits information to and receives information from the display object via the corresponding wireless transmission device in accordance with the data information acquired.

7. The intelligent information interaction system according to claim 2, characterized in that: when there are multiple display objects within the sensing area of the mobile terminal, the mobile terminal determines whether the display objects are located in front of the front face of the mobile terminal in accordance with own orientation and the orientation of the display objects;
if one display object is located in front of the front face of the mobile terminal, the mobile terminal acquires the corresponding data information from the data storage unit in accordance with the identification of this display object; and
if multiple display objects are located in front of the front face of the mobile terminal, the mobile terminal acquires the identification of the display object with the strongest signal intensity or specific signal pattern in accordance with the intensity of the sensed wireless signal, and acquires the corresponding data information from the data storage unit in accordance with the identification of the display object.

8. The intelligent information interaction system according to claim 3, characterized in that: when there are multiple display objects within the sensing area of the mobile terminal, the mobile terminal determines whether the display objects are located in front of the front face of the mobile terminal in accordance with own orientation and the orientation of the display objects;
if one display object is located in front of the front face of the mobile terminal, the mobile terminal acquires the corresponding data information from the data storage unit in accordance with the identification of this display object; and
if multiple display objects are located in front of the front face of the mobile terminal, the mobile terminal acquires the identification of the display object with the strongest signal intensity or specific signal pattern in accordance with the intensity of the sensed wireless signal, and acquires the corresponding data information from the data storage unit in accordance with the identification of the display object.

9. An intelligent information interaction system, characterized in that: the system comprises: a server, a mobile terminal and at least one display object;
a unique identification is assigned to each display object, and data information displayed on the display object or data information relevant to the data information displayed on the display object, which corresponds to each identification, is stored on the server; and the position information of each display object is stored on the server;
the mobile terminal acquires own position information and then sends the acquired position information to the server; the server sends the identifications of the display objects within a predetermined range near the mobile terminal to the mobile terminal in accordance with the position information of the mobile terminal and the position information of each display object, and the mobile terminal, in accordance with the received identifications, acquires the data information corresponding to the identifications from the server.

10. The intelligent information interaction system according to claim 9, characterized in that: information about the orientation and the predetermined viewable angle of each display object is also stored on the server;
the server sends the identification of the display object within a predetermined range near the mobile terminal to the mobile terminal, and also sends the orientation and the predetermined viewable angle of the display object to the mobile terminal simultaneously;
the mobile terminal forms a sector area at the predetermined viewable angle spreading to the left and right sides by taking own orientation as a central axis, wherein the sector serves as a sensing area of the mobile terminal, and the mobile terminal then determines whether the display object is within the sensing area of the mobile terminal according to the orientation of the display object;
if the display object is within the sensing area of the mobile terminal, the mobile terminal, in accordance with the identification of the display object, acquires the data information corresponding to the identification from the server.

11. The intelligent information interaction system according to claim 9, characterized in that: the mobile terminal, after acquiring the corresponding data information, transmits information to and receives information from other servers in accordance with the acquired data information.

12. The intelligent information interaction system according to claim 10, characterized in that: the mobile terminal, after acquiring the corresponding data information, transmits information to and receives information from other servers in accordance with the acquired data information.

13. The intelligent information interaction system according to claim 10, characterized in that: when there are multiple display objects within the sensing area of the mobile terminal, the mobile terminal determines whether the display objects are located in front of the front face of the mobile terminal in accordance with own orientation and the orientation of the display objects;
if one display object is located in front of the front face of the mobile terminal, the mobile terminal, in accordance with the identification of this display object, acquires the data information corresponding to the identification from the server; and
if multiple display objects are located in front of the front face of the mobile terminal, the mobile terminal, in accordance with the identification of the display object closest to the mobile terminal, acquires the data information corresponding to the identification from the server.

14. The intelligent information interaction system according to claim 9, characterized in that: the mobile terminal acquires own geographic coordinates from a map service provider at fixed time intervals by means of wireless network access; or the mobile terminal acquires own geographic coordinates from the map service provider by means of wireless network access when receiving a key instruction or a touch instruction; or the mobile terminal is provided with a movement mode detection module therein, and the movement mode detection module triggers the mobile terminal to acquire own geographic coordinates from the map service provider by means of wireless network access when detecting that the mobile terminal is under a predetermined movement mode.

15. The intelligent information interaction system according to claim 10, characterized in that: the mobile terminal acquires own geographic coordinates from a map service provider at fixed time intervals by means of wireless network access; or the mobile terminal acquires own geographic coordinates from the map service provider by means of wireless network access when receiving a key instruction or a touch instruction; or the mobile terminal is provided with a movement mode detection module therein, and the movement mode detection module triggers the mobile terminal to acquire own geographic coordinates from the map service provider by means of wireless network access when detecting that the mobile terminal is under a predetermined movement mode.
